(19) United States
(12) Patent Application Publication
(10) Pub. No.: US 2008/0020706 A1
(43) Pub. Date: Jan. 24, 2008

(54) Radio Communication Device

(75) Inventors: Adrian W. Payne, Horley (GB); Deborah L. Raynes, Horley (GB); Richard J. Caldwell, Reigate (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,803

(22) PCT Filed: Mar. 1, 2005
(86) PCT No.: PCT/IB05/50753

§ 371 Date: Sep. 12, 2006

(30) Foreign Application Priority Data
Mar. 17, 2004 (GB) 0406092.7

(51) Int. Cl. H04B 7/00

(52) U.S. Cl. 455/41.2

(57) ABSTRACT

A radio communication device (1) comprises a Radio Frequency (RF) unit (2) for transmitting and receiving radio signals, a link controller (3) for controlling operation of the RF unit (2) and a signal monitor (4) for monitoring signals received by the RF unit (2). A processor (5) is connected to the link controller (3) and the signal monitor (4) and a user interface (6). When it is desired for the communication device (1) to communicate with another device (9), a communication link is established in a conventional way. The signal monitor (4) is able to measure signal strength and the bit error rate (BER) of the signal received in the communication link from the other communication device (9) and outputs these to the processor (5). When the BER is unacceptably high, the processor (5) determines whether the measured signal strength has changed from very high to very low in a short period. This is indicative of the body (10) blocking the signal. If the processor (5) determines that the body (10) is blocking the signal it causes the device (1) to try to maintain the communication link, e.g. by continuing to try to receive a signal in the communication link rather than allowing the link to break normally.

This invention relates to a radio communication device. More specifically, the invention relates to a radio communication device for use near to a body, such as a device intended to be worn by a person. The invention also relates to a method of operating a radio communication device near to a body and a method of determining when a radio signal is blocked by a nearby body.

Short range radio communication systems are becoming increasingly common. For example, many devices have now been developed that use low power radio transmission to communicate with one another over short distances and form so-called “piconets”. Bluetooth® is an example of such technology and Bluetooth® enabled devices include mobile telephones and their peripheral devices, such as headsets and hands-free kits, as well as computers, personal digital assistants (PDAs) and such like. Similarly, the Institute of Electrical and Electronics Engineers (IEEE) has developed several standards for wireless networking, known generically as the 802.1™ Wireless Local Area Network (WLAN) standards and commercially as Wi-Fi®. At present, Wi-Fi® is mostly used for communication between personal computers and a network, e.g. so-called “wireless networks”.

Typically, Bluetooth® devices have a range of around 10 m and Wi-Fi® devices have a range of around 100 m. However, the applicants have recognised that the human body can severely attenuate radio signals. Bluetooth® and Wi-Fi® use a frequency band around 2.4 GHz, although some implementations of Wi-Fi®, such as WLAN system IEEE 802.11a, use a frequency band around 5 GHz instead. At these frequencies, the human body attenuates radio signals by around 200 dB/m, although attenuation varies slightly depending on the part of the body through which the signal passes. This is enough to completely block a Bluetooth® or Wi-Fi® signal.

Body blocking can be mitigated by the ability of radio waves to travel via multiple paths. A radio signal usually propagates most strongly between a transmitter and a receiver along a path that extends directly between them, i.e. the so-called line of sight (LOS) path. This path normally predominates in the communication link. However, the radio signal may also propagate between the transmitter and receiver by reflection, i.e. along so-called reflected paths. This occurs particularly when the transmitter and receiver are used indoors. Thus, even when a body blocks the LOS path, radio communication can be maintained.

However, the applicants have recognised that this may not always be the case and radio communication in short range radio communication systems such as Bluetooth® and Wi-Fi® may rely entirely on the LOS path. For example, when a radio signal propagates via different reflected paths, the separately reflected signals may destructively interfere with one another. This can weaken or destroy the signal and means that reflected paths are not normally reliable for maintaining a communication link.

Reflected paths are also always longer the LOS path. It is therefore quite likely in a short range radio communication system that all possible reflected paths will be out of range. For example, when there are no nearby objects capable of reflecting the radio signal, all reflected paths may be too long. This is very likely when the device is used outside. Furthermore, when the transmitter and receiver are spaced apart from one another such that the signal only just has sufficient strength to travel along the LOS path, the signal will be too weak to use any available reflected paths. This means that the LOS path may be the only available path, even when the device is used inside. This is a particular problem for Bluetooth®, which transmits signals at low power.

It is also possible for antennas through which a radio signal is transmitted and received to be more directional than designed. This can occur when an antenna couples with the device in which it is housed or with nearby objects, such as a user's body. Directional antennas generate far fewer potential reflected paths, as they transmit and receive radio signals in only a narrow range of directions. This again may mean that alternate paths are not available when a propagation path is blocked. For example, reflected paths may not be available and the radio transmission may rely entirely on the LOS path.

So, blocking of radio signals and particularly the LOS path by the human body can often interrupt communication in short range radio communication systems. At the same time, these systems are increasingly used for communication between devices held near the human body, e.g. mobile telephones, and even worn by users, e.g. headsets and medical monitors. For example, it is quite likely that a mobile telephone in a user's back pocket will be unable to communicate with a PDA held in the user's hand using Bluetooth®.

If communication is interrupted, even momentarily, communication links between the devices will fail. Once a link is broken, a user typically has to manually prompt a device to re-establish a link. So, not only is communication interrupted, but the user is also inconvenienced.

The present invention seeks to overcome these problems.

According to one aspect of the present invention, there is provided a radio communication device for use near to a body, the device comprising:

a receiver for receiving a radio signal in a communication link with another radio communication device;

a detector for detecting deterioration in quality of the radio signal; and

a processor for determining if the detected deterioration in signal quality is likely to be caused by the body blocking the signal and, upon such determination, causing the device to try to maintain the communication link.

According to a second aspect of the present invention, there is provided a method of operating a radio communication device near to a body, the method comprising:

receiving a radio signal in a communication link with another radio communication device;

detecting deterioration in quality of the radio signal; and

determining if the detected deterioration in signal quality is likely to be caused by the body blocking the signal and, upon such determination, causing the device to try to maintain the communication link.

For example, the device may monitor the strength of the radio signal it receives from the other communication device. When the signal strength falls, the device may analyse the way in which the signal strength has changed to determine if the signal is being blocked by the body. If the analysis indicates that the body is likely to be blocking the signal, specific action can be taken to maintain the communication link. For example, the blocking of signals by a user's body is often transient, so the device might keep trying to receive signals in the communication link for longer than it would otherwise. In another example, the device may alert the user to move the device in relation to their body and thus improve the communication link.

This has the advantage that signal quality is given time to improve or signal reception can be re-established before the communication link is broken. The need for the device to re-establish the communication link is therefore avoided and continuity of communication is improved. In particular, there is less likelihood that a user will need to initiate re-establishment of the communication link manually after inadvertently blocking it with their body.

At the same time, when the device determines that deterioration in signal quality is not likely to be caused by the body, the communication link can be allowed to break normally, e.g. as specified by the appropriate system specification or standard. In other words, the processor may otherwise allow the link to terminate. For example, when devices move out of range from one another, the communication link can be allowed to break without delay. Similarly, the user may not be needlessly alerted that the communication link is about to break or can be alerted in a different way. Thus, by distinguishing between deteriorations signal quality caused by the body blocking the signal and other causes, the device can manage the communication link more effectively.

As apparent above, the invention is particularly useful in dealing with users blocking signals with their own bodies. However, the invention is not limited to determining when only a user's body is blocking the signal. Rather, the likelihood that the signal is blocked by any nearby body can be determined. This might include a human or animal body or other objects that strongly attenuate radio signals, such as metal objects etc. So, the device is generally intended to be used near a body that strongly attenuates radio signals.

One and/or other of the devices may typically be a mobile telephone. Alternatively, it/they may be a peripheral device for use with a mobile telephone, such as a headset. In another example, one and/or other of the devices might be a medical sensor. More generally, one and/or other of the devices may be worn by a user. In other words, one or other of the devices may be intended to be worn on a human or animal body. Indeed the device may be a wearable device.

As mentioned above, there are various ways in which the device may try to maintain the communication link. In one example, the device may try to maintain the communication link by continuing to try to receive the signal after signal quality has deteriorated (e.g. to an unacceptably low level or to a level at which data transfer cannot be achieved) for longer than it would otherwise. In other words, the processor may cause the device to try to maintain the communication link by extending the time for which the receiver continues to try to receive signals in the communication link after signal quality has deteriorated. Similarly, the method may comprise causing the device to try to maintain the communication link by extending the time for which it continues to try to receive signals in the communication link after signal quality has deteriorated.

The communication link might be a defined communication channel and the device may try to maintain the communication link by continuing to try to receive a signal in the defined communication channel. For example, Bluetooth® signals are transmitted in channels defined by frequency hopping sequences. Conventionally, when the signal quality deteriorates to an extent that the signal can no longer be successfully received, e.g. demodulated and decoded, the device stops trying to receive a signal in the channel, e.g. stops frequency hopping in the defined sequence. So, in accordance with the invention, the communication link can comprise a defined frequency hopping sequence and the device can try to maintain the communication link by extending the time that it continues to frequency hop in the defined sequence after signal quality has deteriorated.

Communication links and, in particular, the frequency hopping sequences of Bluetooth® are often synchronised between devices. This is usually achieved by frequently transmitting timing information in the radio signal to synchronise the devices' internal clocks. Without these timing signals, the clocks of the respective devices become unsynchronised, as they naturally run at very slightly different rates. When signal quality is poor, it may be possible still to retrieve timing information from the signal. So, in one example, it is preferred that the processor causes the device to try to maintain the communication link by causing the receiver to continue to try to maintain synchronisation timing with the other device after signal quality has deteriorated. In other words, it is preferred that the method comprises causing the device to try to maintain the communication link by causing the receiver to continue to try to maintain synchronisation timing with the other device after signal quality has deteriorated.

However, when signal quality is poor, it may not be possible to synchronise the devices' internal clocks and the devices may become unsynchronised. In this case, there is little point in continuing to try to receive the radio signal, e.g. by frequency hopping in the defined sequence, after the device's clock is likely to have lost synchronisation with that of the other device. The processor may therefore cause the receiver to stop to trying to maintain the communication link after a certain period, e.g. a few seconds. However, the applicants have recognised that, even when it is not possible to successfully decode and demodulate the received signal and, e.g., recover timing information for synchronisation, it may be possible to identify whether or not the devices are still synchronised. This can be achieved by filtering the received signal. Of course, radio receivers usually filter radio signals on receipt to reduce noise and such like. However, in this example, the processor may cause the receiver to filter the radio signal more narrowly than usual (e.g. than during normal signal reception, such as when the signal is successfully decoded and demodulated). For example, this can allow the frequency of a weak signal to be determined, which can then be used to confirm whether or not the devices' frequency hopping is still synchronised. So, it is preferred that the processor causes the receiver to switch to filtering the radio signal more narrowly to determine whether or not the device is still synchronised with the other device. If the devices are no longer synchronised, the processor may cause the device to stop trying to maintain the communication link. In other words, the processor may cause the receiver to detect when the device remains synchronised with the other device and only cause the device to continue to try to maintain the communication link whilst the devices remain synchronised. Likewise, the method may comprise causing the receiver to detect when the device remains synchronised with the other device and only causing the device to continue to try to maintain the communication link whilst the devices remain synchronised.

Other action can additionally or alternatively be taken by the mobile device to try to maintain the communication link. For example, the communication device typically has a user interface. This might be a display screen, e.g. for displaying alphanumeric characters and/or pictures. Alternatively, the user interface may be a loudspeaker, light, vibration mechanism or other alerting mechanism. The device may therefore try to maintain the communication link by alerting a user that the body is blocking the signal via a user interface. In other words, the device may further comprise a user interface and the processor may cause the device to try to maintain the communication link by alerting the user via the user interface. Similarly, the method may include causing the device to try to maintain the communication link by alerting the user via a user interface. For example, the device may display a message on a display screen. Additionally or alternatively, the device may emit a sound from the loudspeaker; illuminate the light; or activate the vibration mechanism or other alerting mechanism. This should prompt the user to move the device relative to the body, e.g. the user's body, and maintain the communication link.

As well as receiving the radio signal from the other device, the device typically transmits a radio signal to the other device, e.g. in the same communication link. The processor may therefore cause the device to try to maintain the communication link by altering transmission of a radio signal to the other communication device. In other words, the method may include causing the device to try to maintain the communication link by altering transmission of a radio signal to the other communication device. For example, if the received signal is blocked by the body, it is very likely that the signal transmitted by the device to the other device will also be blocked by the body. The device may therefore increase the power at which it transmits a radio signal, e.g. in the communication link. Similarly, the device may transmit a signal to the other communication device requesting the other communication device to increase the power at which it transmits signals in the communication link.

In another example, the device may have an adaptable antenna arrangement. For example, the device may have more than one antenna, at least one of which is directional. Alternatively, the antenna arrangement may comprise a controllable antenna array. So, the processor may cause the device to try to maintain the communication link by controlling the adaptable antenna arrangement to enhance a propagation path. Similarly, the method may include causing the device to try to maintain the communication link by controlling an adaptable antenna arrangement to enhance a propagation path. This might involve switching to use the directional antenna in addition to or instead of another antenna, e.g. a multi-directional antenna.

The above examples of how the device may try to maintain the communication link are illustrative rather than exhaustive. Furthermore, they may be combined in a variety of ways. For example, the processor may cause the device to initiate two or more ways of trying to maintain the communication link at substantially the same time. Alternatively, the device may initiate one way of trying to maintain the communication link followed by another way of trying to maintain the communication link. It is particularly preferred that the device only tries the other way of trying to maintain the communication link if signal quality remains poor for a predetermined period. For example, the device may extend the period for which it keeps trying to receive a signal in the communication link and, if after a given time signal quality remains poor, alert the user via a user interface.

Turning now to how the device determines when the radio signal is likely to be blocked by the body, the applicants have identified a number of useful indicators that the signal may be blocked by a body rather than otherwise attenuated. For example, as a transmitter and receiver move away from one another, signal quality tends to decrease fairly slowly. A large number of data packets may be received during the time that signal quality deteriorates and consecutive data packets will generally show only small changes in signal quality. However, when the device is used near a body, e.g. held by a user, and the body, e.g. the user's body, comes between the device and the other device with which it is communicating, the applicants have recognised that signal quality is likely to deteriorate very quickly. Determining when signal quality deteriorates from good to bad very quickly can therefore provide a good indication of when the signal is blocked by a body. Indeed, it is preferred that the processor determines that the detected deterioration in signal quality is likely to be caused by the body blocking the signal when the detected signal quality deteriorates from a good (or, e.g., acceptable) level to a bad (or, e.g., unacceptable) level in less than a given period. In other words, it is preferred that the method includes determining that the detected deterioration in signal quality is likely to be caused by the body blocking the signal when the detected signal quality deteriorates from a good level (or, e.g., acceptable) to a bad (or, e.g., unacceptable) level in less than a given period. The good or acceptable level is typically almost the best possible signal quality. The bad or unacceptable level is typically almost no receivable signal. The given period is typically short, e.g. around the same as or less than the length of time it takes to receive one data packet.

This determination of when a body is likely to be blocking a signal propagation path is believed to be new in itself. According to a third aspect of the present invention, there is therefore provided a radio communication device for use near to a body, the device comprising:

a detector for detecting the quality of a received radio signal; and

a processor for determining that the signal is likely to have been blocked by the body if the detected signal quality deteriorates from an acceptable level to an unacceptable level in less than a given period.

According to a fourth aspect of the present invention, there is provided a method of determining when a radio signal is blocked by a nearby body, the method comprising:

detecting the quality of a received radio signal; and

determining that the signal is likely to have been blocked by the body if the detected signal quality deteriorates from an acceptable level to an unacceptable level in less than a given period.

Signal quality can be measured in a variety of ways. For example, signal quality may be considered to be acceptable when data packets in the signal can be successfully received, e.g. demodulated or decoded. Likewise, signal quality may be considered to be unacceptable when data packets in the signal cannot be successfully received, e.g. demodulated or decoded. However, most indicators of signal quality are variables, such as signal strength for example. Variables can most usefully be compared to threshold levels to determine when signal quality is acceptable and when it is unacceptable. So, in one example, it is preferred that the processor compares the detected signal quality to a good signal quality threshold level and to a bad signal quality threshold level and determines that the signal is likely to have been blocked by the body when the detected signal quality deteriorates from the good signal threshold level to the bad level threshold level. In other words, the method preferably comprises comparing the detected signal quality to a good signal quality threshold level and to a bad signal quality threshold level and determining that the signal is likely to have been blocked by the body when the detected signal quality deteriorates from the good signal quality threshold level to the bad signal quality level threshold level.

The values of the good and bad threshold levels depend on the signal quality indicator that is detected. For example, signal strength is a useful indicator of signal quality. The detector may therefore detect the strength of the received signal. This might be detected using a received signal strength indicator (RSSI). Alternatively, signal to noise ratio (SNR) can be detected. So, the processor would typically determine that the signal is likely to have been blocked by the body when the detected signal strength falls from (e.g. above) the good signal quality threshold level to (e.g. below) the bad signal quality threshold level. In other words, the method may comprise determining that the signal is likely to have been blocked by the body when the detected signal strength falls from (e.g. above) the good signal quality threshold level to (e.g. below) the bad signal quality threshold level. In this case, the good signal quality threshold level might be, say, around −45 dBm. Similarly, the bad signal quality threshold level might be, say, around −95 dBm.

Another indicator of signal quality is bit error rate (BER). The detector may therefore detect the BER of a received signal. So, the processor would typically determine that the signal is likely to have been blocked by a nearby body when the detected BER increases from (e.g. below) the good signal quality threshold level to (e.g. above) the bad signal quality threshold level. In other words, the method may comprise determining that the signal is likely to have been blocked by a nearby body when the detected BER increases from (e.g. below) the good signal quality threshold level to (e.g. above) the bad signal quality threshold level. The good signal quality threshold level might be, say, substantially 0.01%. Similarly, the bad signal quality threshold level might be, say, around 50%.

Yet another good indicator of signal quality is delay spread. This is a measure of the spread of different times at which a receiver receives an individual component of the signal as a result of the signal component travelling to the receiver via different paths. This is very useful in the present invention, as low delay spread is particularly indicative of a signal being received via a LOS path and high delay spread is particularly indicative of a signal being received via one or more reflected paths. So, a quick change in delay spread from low to high is indicative of a change in propagation path from a LOS path to a reflected path. This, in turn, is indicative of body blocking. In a particularly preferred example, the detector may therefore detect the delay spread of the radio signal. In this case, the processor would typically determine that the signal is likely to have been blocked by the body when the detected delay spread increases from (e.g. below) the good signal quality threshold level to (e.g. above) the bad signal quality threshold level. In other words, the method may comprise determining that the signal is likely to have been blocked by the body when the detected delay spread increases from (e.g. below) the good signal quality threshold level to (e.g. above) the bad signal quality threshold level.

The average time of flight of data packets is usually related to delay spread. This is also therefore a good indicator of signal quality and, in particular, body blocking. In another preferred example, the detector therefore detects the time of flight of data packets received in the radio signal. In this case, the processor would typically determine that the signal is likely to have been blocked by the body when the detected time of flight increases from (e.g. below) the good signal quality threshold level to (e.g. above) the bad signal quality threshold level. Likewise, the method my include determining that the signal is likely to have been blocked by the body when the detected time of flight increases from (e.g. below) the good signal quality threshold level to (e.g. above) the bad signal quality threshold level.

The speed with which the signal quality deteriorates when a body blocks the signal path is typically very quick. The given period within which it is determined if the detected signal quality deteriorates from the good level to the bad level is therefore very short. For example, the period may be approximately the same as or less that the duration of one packet of data in the received signal. In Bluetooth® this may be 625 μs, or longer where a packet spans more than one time slot. The given period is typically therefore less than around 1 ms.

However, very temporary reductions in signal quality can occur from time to time, for example when two data packets collide, without the body blocking the signal. The processor may therefore only determine that the detected deterioration in signal quality is likely to be caused by the body blocking the signal when the signal quality remains deteriorated for more than a given duration (or minimum period). The duration is typically more than the duration of one packet of data in the signal and usually the duration of several packets. As mentioned above, in Bluetooth® the minimum period for one packet is 625 μs. The duration is therefore typically around a few milliseconds.

Any one of the above signal quality indictors can provide reliable indication of body blocking when taken alone. However, in order to improve accuracy, the determination may be based on more than one signal quality indicator. For example, the processor may determine that the detected deterioration in signal quality is likely to be caused by the body when a first signal quality indicator indicates rapid deterioration in signal quality (e.g. as set out above) and a second signal quality indicator confirms that the signal quality has deteriorated (e.g. as set out above). A specific example of this might be detecting signal strength deteriorating from the good level to the bad level in less than the given period and also detecting that BER has deteriorated to the bad level. Another specific example might be detecting BER deteriorating from the acceptable level to the unacceptable level in less than the given period and also detecting that signal strength has deteriorated to the unacceptable level.

The applicants have also recognised that, when short range radio communication devices are used near a body, the range between the devices is likely to be very short. Estimating the range from which the signal is received can therefore be useful in indicating when a signal is likely to have been blocked by a body. So, it is preferred that the processor estimates when the range from which the signal is received is very short and determines that the signal is likely to have been blocked by the body if the range is estimated to be very short when the signal quality deteriorates. In other words, it is preferred that the method includes estimating when the range from which the signal is received is very short and determining that the signal is likely to have been blocked by the body if the range is estimated to be very short when the signal quality deteriorates.

In the most straightforward scenario, the processor can estimate when the range from which the signal is received is very short by comparing the detected signal quality to a short range indication threshold level. For simplicity, the short range indication threshold level may be the same as the good signal quality threshold level. So, the processor can estimate that the range is very short when the detected signal quality is better than the good signal quality threshold level.

However, in some communication systems, the range from which signals are received is known. For example, the power with which a signal is transmitted might be known, e.g. because it is always the same or because different types or classes of device transmit at different constant power and the class or type of the other device is known. Alternatively, the other device may transmit an indication of the power at which it is transmitting the signal in the communication link. So, the device may measure the received signal strength and compare it to the strength at which the signal was transmitted to derive a range value. The device may then estimate that the range is very short when the derived range value is below a short range threshold. This might be 1 m for example, which is a typical range between two devices both held by a single user, e.g. being used in a body area network (BAN).

Use of the word “processor” above is intended to be general rather than specific. Whilst some aspects of the invention may be carried out using an individual processor, such as a digital signal processor (DSP) or central processing unit (CPU), they could equally well be carried out in other parts or components of the device. For example, a Radio Frequency (RF) unit may include some processing functionality and/or the device may include multiple processors for carrying out different aspects of the invention. Similarly, the invention could be implemented using a hard-wired circuit or circuits, or by embedded software. For example, the invention may be implemented using composite metal oxide semiconductor (CMOS) circuitry.

It can also be appreciated that the invention can be implemented using computer program code. According to a further aspect of the present invention, there is therefore provided computer software or computer program code adapted to carry out the method described above when processed by a processing means. The computer software or computer program code can be carried by computer readable media. The media may be a physical storage media such as a Read Only Memory (ROM) chip. Alternatively, it may be a disk such as a Digital Video Disk (DVD-ROM) or Compact Disk (CD-ROM). It could also be a signal such as an electronic signal over wires, an optical signal or a radio signal such as to a satellite or the like. The invention also extends to a processor running the software or code, e.g. a computer configured to carry out the method described above.

Preferred embodiments of the invention will now be described, by way of example only, with reference to the accompanying drawings, in which:

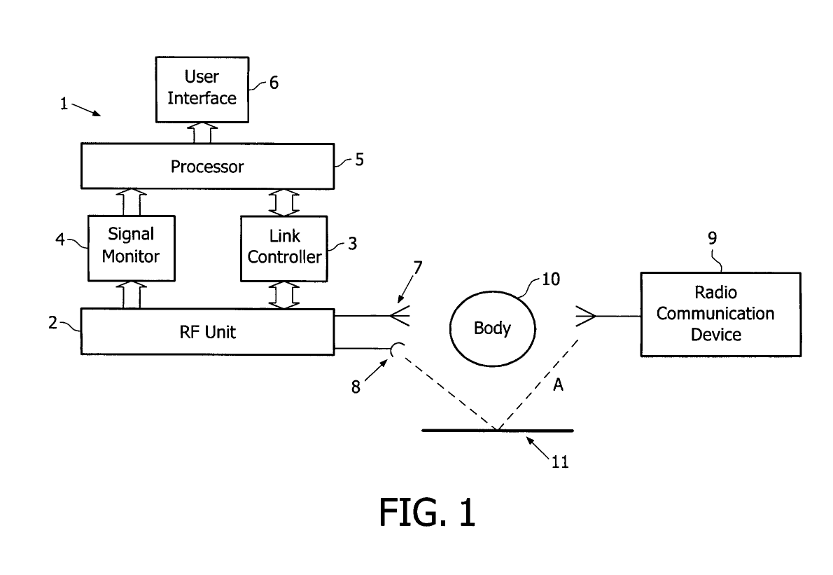

FIG. 1 is a schematic illustration of a radio communication device according to the invention in operation; and

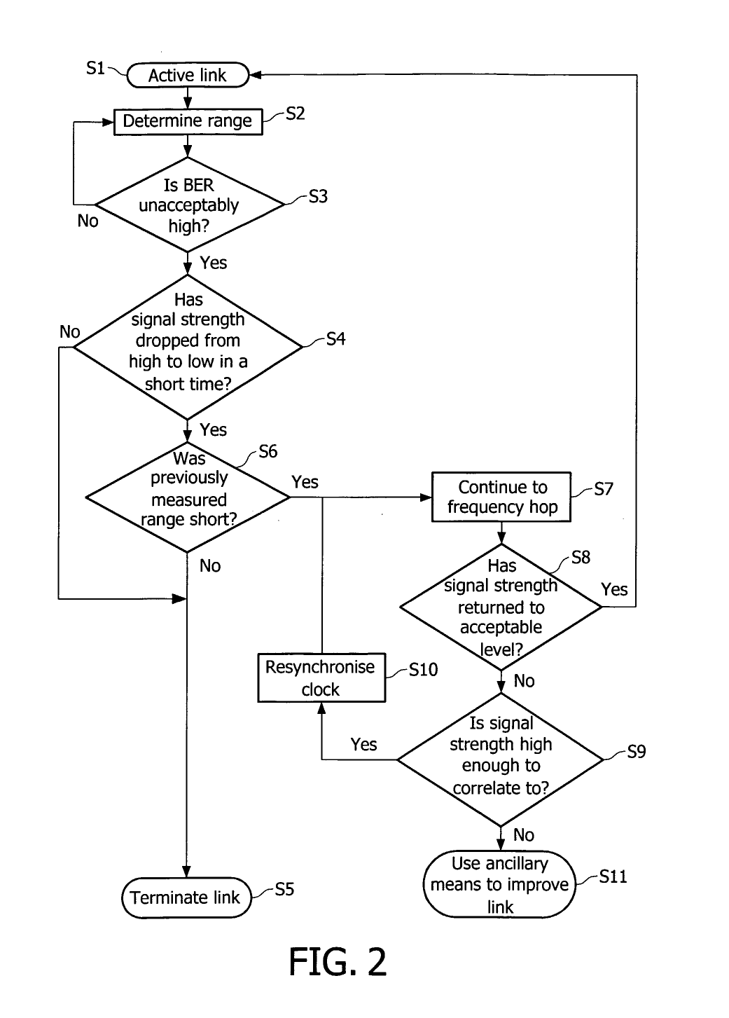

FIG. 2 is a flow chart illustrating operation of the device of FIG. 1.

Referring to FIG. 1, a radio communication device 1 comprises a Radio Frequency (RF) unit 2 for transmitting and receiving radio signals. In this embodiment, the radio communication device 1 is configured according to the latest version of the Bluetooth® specification, which is known as Core Specification v1.2, dated 5 Nov. 2003 and available from Bluetooth SIG, Inc. The invention is largely illustrated using just this embodiment, but it is applicable to a variety of other short range radio communication systems, including in particular Wi-Fi® systems. Some appropriate implementation details for communication systems other than Bluetooth® are mentioned below, but many others will be apparent to those skilled in the art.

As well as RF unit 2, the communication device 1 has a link controller 3 for controlling operation of the RF unit 2 and a signal monitor 4 for monitoring signals received by the RF unit 2. A processor 5 is connected to the link controller 3 and the signal monitor 4 and, in this embodiment, also to a user interface 6. Whilst the user interface 6 is not necessary to implement most aspects of the invention, it is usually provided when the device is a mobile telephone or such like and typically comprises one of: a screen for displaying characters or images; a visual indicator such as a light or LED; an audible indicator such as a loudspeaker; or a tactile indicator such as a vibration mechanism.

The RF unit 2 transmits and receives signals via an antenna array 7,8 which is typically designed to be selectively either directive or multi-directional/omni-directional. For clarity, the antenna array 7,8 is shown as a separate multi-directional antenna 7 and a directional antenna 8 in FIG. 1, although in reality the antennas are combined in a single controllable antenna array 7,8. So, the antenna array 7, 8 can be referred to as an adaptable antenna and the RF unit 2 can selectively control the antenna array 7,8 to be directional or multi-directional/omni-directional as desired.

Also illustrated in FIG. 1 is another radio communication device 9, with which the communication device 1 can communicate; a body 10 positioned to block the line of sight (LOS) path between the two devices 1,9; and an environmental feature 11, such as a wall, that is an effective reflector of radio signals.

Referring to FIG. 2, when it is desired for the communication device 1 to communicate with the other device 9, a communication link is established in a conventional way. This involves the link controller 3 synchronising the clock of the communication device 1 with the clock of the other communication device 9 and the devices 1,9 allocating one or more channels for communication. In Bluetooth®, each channel comprises a frequency hopping sequence synchronised between the devices 1,9. When available, more than one channel can be allocated for communication between the two devices 1,9 to increase communication capacity. So, referring to FIG. 2, there is an active communication link between the devices 1,9 at step S1.

The signal monitor 4 begins to monitor the signal received in the communication link as soon as it is established. The signal monitor 4 is able to measure signal strength, e.g. a received signal strength indicator (RSSI), over a wide dynamic range, although this measurement does not have to be very precise. The signal monitor 4 periodically outputs the measured signal strength to the processor 5. The processor 5 also determines the power at which the other communication device 9 is transmitting a signal. This can be achieved by the other communication device 9 transmitting an indication of the power at which it is transmitting to the communication device 1. The processor 5 can then compare the measured signal strength with the determined transmitted signal strength to estimate the range between the devices 1,9, as shown in step S2 of FIG. 2. The estimated range is then stored in a buffer (not shown) that can store several range estimations, say for the last few seconds.

At the same time, the signal monitor 4 measures the bit error rate (BER) of the signal received in the communication link from the other communication device 9 and outputs it to the processor 5. The processor 5 compares the BER to a threshold value, which in this embodiment is 50%, as shown in step S3 of FIG. 2. If the BER is above the threshold value, then the processor 5 determines that the BER is unacceptably high. If the BER remains below the threshold value, then the processor continues to monitor the range between the devices (step S2) and the BER level (step S3).

When the BER is unacceptably high, the processor 5 determines whether the measured signal strength has changed from very high to very low in a short period. For example, the processor 5 may compare recent signal strength measurements from the signal monitor 4 with a first threshold value, say −40 dBm, to determine the time, if any, at which the signal strength passed through the first threshold. The processor 5 may also compare the signal strength measurements with a second (lower) threshold value, say −95 dBm, to determine the time, if any, at which the signal passed through the second threshold. The processor 5 then compares the difference between the two times, i.e. the time it takes for the signal strength the pass between the two thresholds, to a given period, e.g. 1 ms. If the time is shorter than the given period, then the processor 5 determines that the signal strength has dropped from high to low in a short time (step S4). This is indicative of the body 10 blocking the signal. Otherwise, the processor 5 determines that the body 10 is not blocking the signal and proceeds to terminate the communication link conventionally (step S5).

In order to verify that the body 10 is likely to be blocking the signal, the processor 5 checks the range of the signal (step S6). To do this, the processor 5 looks up the range estimations in the buffer. In particular, the processor 5 identifies the range estimation immediately before the time at which the signal quality started to deteriorate, e.g. the time at which the signal strength passed through the first threshold. The processor 5 compares this range to a threshold range, e.g. 1 m, and, if the estimated range is below the threshold range, determines that the range was short. Otherwise, the processor 5 determines that the body 10 is not blocking the signal and proceeds to terminate the communication link conventionally (step S5).

When the signal strength has dropped from high to low in a short time (step S4) and the range was short (step S6), the processor instructs the link controller 3 to cause the RF unit to continue to frequency hop in the defined sequence for the channel currently in use (step S7). The processor 5 then monitors the signal strength output by the signal monitor to determine whether or not the signal has returned to an acceptable level (step S8). More specifically, the processor determines when the signal strength returns to above an acceptable threshold level, which might be the same as the first threshold level, say −40 dBm. If the signal strength returns to an acceptable level, the device 1 has a normal active link and returns to step S1 shown in FIG. 2. Otherwise, the processor 5 determines whether or not the signal strength is high enough to allow synchronisation between the devices 1,9 (step S9).

If signal strength is high enough to allow synchronisation information to be retrieved from the signal, the link controller 3 can resynchronise the device's clock (step S10) and continue to frequency hop (step S7). Otherwise, the processor 5 can use ancillary means to improve the link. In this embodiment, this involves the processor 5 alerting the user to move the device via the user interface 6. More specifically, the processor 5 may cause the user interface to display a message; illuminate a light; emit a sound; or vibrate according to the capability of the user interface. In this embodiment, the processor 5 also switches the antenna 7,8 to be more directional towards a likely reflected path, which may be better able to propagate a signal from the other device 9, e.g. via reflected path A created by environmental feature 11 shown in FIG. 1.

When signal quality deteriorates, the processor 5 also causes the RF unit 2 to filter the received signal more narrowly in order to determine the frequency of the received signal. This is compared with the frequency hopping of the RF unit 2 in the communication link to determine whether or not the devices continue to be synchronised. If synchronisation is lost, the processor 5 stops trying to maintain the communication link.

The described embodiments of the invention are only examples of how the invention may be implemented. Modifications, variations and changes to the described embodiments will occur to those having appropriate skills and knowledge. These modifications, variations and changes may be made without departure from the spirit and scope of the invention defined in the claims and its equivalents.

1. A radio communication device (1) for use near to a body (10), the device (1) comprising:
a receiver (2) for receiving a radio signal in a communication link with another radio communication device (9);
a detector (4) for detecting deterioration in quality of the radio signal; and
a processor (5) for determining if the detected deterioration in signal quality is likely to be caused by the body (10) blocking the signal and, upon such determination, causing the device (1) to try to maintain the communication link.

2. The radio communication device (1) of claim 1, wherein the processor (5) causes the device (1) to try to maintain the communication link by extending the time for which the receiver (2) continues to try to receive signals in the communication link after signal quality has deteriorated.

3. The radio communication device (1) of claim 1, wherein the processor (5) causes the device (1) to try to maintain the communication link by causing the receiver (2) to continue to try to maintain timing synchronisation with the other device (9) after signal quality has deteriorated.

4. The radio communication device (1) of claim 1, further comprising a user interface (6) and wherein the processor (5) causes the device (1) to try to maintain the communication link by alerting a user via the user interface (6).

5. The radio communication device (1) of claim 1, wherein the processor (5) causes the device (1) to try to maintain the communication link by altering transmission of a radio signal to the other communication device (9).

6. The radio communication device (1) of claim 1, further comprising an adaptable antenna arrangement (7,8) and wherein the processor (5) causes the device (1) to try to maintain the communication link by controlling the antenna arrangement (7,8) to enhance a propagation path.

7. The radio communication device (1) of claim 1, wherein the processor (5) determines that the detected deterioration in signal quality is likely to be caused by the body (10) blocking the signal when the detected signal quality deteriorates from an acceptable level to an unacceptable level in less than a given period.

8. A radio communication device (1) for use near to a body (10), the device (1) comprising:
a detector (4) for detecting the quality of a received radio signal; and
a processor (5) for determining that the signal is likely to have been blocked by the body (10) if the detected signal quality deteriorates from an acceptable level to an unacceptable level in less than a given period.

9. The radio communication device (1) of claim 1, wherein the processor (5) compares the detected signal quality with a good signal quality threshold level and a bad signal quality threshold level and determines that the signal is likely to have been blocked by the body (10) if the detected signal quality deteriorates from the good signal quality threshold level to the bad signal quality threshold level.

10. The radio communication device (1) of claim 1, wherein the detector (4) detects the strength of the received signal and the processor (5) determines that the signal is likely to have been blocked by the body (10) based on the detected signal strength.

11. The radio communication device (1) of claim 1, wherein the detector (4) detects the bit error rate of the received signal and the processor (5) determines that the signal is likely to have been blocked by the body (10) based on the detected bit error rate.

12. The radio communication device (1) of claim 1, wherein the detector (4) detects the delay spread of the radio signal and the processor (5) determines that the signal is likely to have been blocked by the body (10) based on the detected delay spread.

13. The radio communication device (1) of claim 1, wherein the detector (4) detects the time of flight of data packets in the received signal and the processor (5) determines that the signal is likely to have been blocked by the body (10) based on the detected time of flight.

14. The radio communication device (1) of claim 1, wherein the given period is less than the duration of a data packet in the received signal.

15. The radio communication device (1) of claim 1, wherein the processor (5) determines that the signal is likely to have been blocked by the body (10) only if the detected signal quality remains deteriorated for more than a minimum period.

16. The radio communication device (1) of claim 1, wherein the processor (5) estimates when the range from which the signal is received is very short and determines that the detected deterioration in signal quality is likely to be caused by the body (10) blocking the signal only if the range was very short when the signal quality deteriorated.

17. The radio communication device (1) of claim 9, wherein the processor (5) estimates that the range from which the signal is received is very short when the detected signal quality is better than the good signal quality threshold level.

18. The radio communication device (1) of claim 1, wherein the processor (5) estimates the range from which the signal is received by comparing received signal strength with the strength at which the signal was transmitted.

19. The radio communication device (1) of claim 1, wherein the processor (5) causes the receiver (2) to detect when the device (1) remains synchronised with the other device (9) and only causes the device (1) to continue to try to maintain the communication link whilst the devices (1,9) remain synchronised

20. A wearable radio communication device (1) according to claim 1.

21. A method of operating a radio communication device (1) near to a body (10), the method comprising:
receiving a radio signal in a communication link with another radio communication device (9);
detecting deterioration in quality of the radio signal; and
determining if the detected deterioration in signal quality is likely to be caused by the body (10) blocking the signal and, upon such determination, causing the device (1) to try to maintain the communication link.

22. The method of claim 21, comprising causing the device (1) to try to maintain the communication link by extending the time for which the device (1) continues to try to receive signals in the communication link after signal quality has deteriorated.

23. The method of claim 21, comprising causing the device (1) to try to maintain the communication link by continuing to try to maintain synchronisation timing with the other device (9) after signal quality has deteriorated.

24. The method of claim 21, comprising causing the device (1) to try to maintain the communication link by alerting a user via a user interface (6).

25. The method of claim 21, comprising causing the device (1) to try to maintain the communication link by altering transmission of a radio signal to the other communication device (9).

26. The method of claim 21, comprising causing the device (1) to maintain the communication link by controlling an adaptable antenna arrangement (7,8) to enhance a propagation path.

27. The method of claim 21, comprising determining that the detected deterioration in signal quality is likely to be caused by the body (10) blocking the signal when the detected signal quality deteriorates from an acceptable level to an unacceptable level in less than a given period.

28. A method of determining when a radio signal is blocked by a nearby body (10), the method comprising:
detecting the quality of a received radio signal; and
determining that the signal is likely to have been blocked by the body (10) if the detected signal quality deteriorates from an acceptable level to an unacceptable level in less than a given period.

29. The method of claim 21, comprising comparing the detected signal quality with a good signal quality threshold level and a bad signal quality threshold level and determining that the signal is likely to have been blocked by the body (10) if the detected signal quality deteriorates from the good signal quality threshold level to the bad signal quality threshold level.

30. The method of claim 21, comprising detecting the strength of the received signal and determining that the signal is likely to have been blocked by the body (10) based on the detected signal strength.

31. The method of claim 21, comprising detecting the bit error rate of the received signal and determining that the signal is likely to have been blocked by the body (10) based on the detected bit error rate.

32. The method of claim 21, comprising detecting the delay spread of the radio signal and determining that the signal is likely to have been blocked by the body (10) based on the detected delay spread.

33. The method of claim 21, comprising detecting the time of flight of data packets in the received signal and determining that the signal is likely to have been blocked by the body (10) based on the detected time of flight.

34. The method of any claim 21, wherein the given period is less than the duration of a data packet in the received signal.

35. The method of claim 21, comprising determining that the signal is likely to have been blocked by the body (10) only if the detected signal quality remains deteriorated for more than a minimum period.

36. The method of claim 21, comprising estimating when the range from which the signal is received is very short and determining that the detected deterioration in signal quality is likely to be caused by the body (10) blocking the signal only if the range was very short when the signal quality deteriorated.

37. The method of any claim 29, comprising estimating that the range from which the signal is received is very short when the detected signal quality is better than the good signal quality threshold level.

38. The method of claim 21, comprising estimating the range from which the signal is received by comparing received signal strength with the strength at which the signal was transmitted.

39. The method of claim 21, comprising detecting when the device (1) remains synchronised with the other device (9) and only continuing to try to maintain the communication link whilst the devices (1,9) remain synchronised

40. Computer program code adapted to carry out the method of claim 21 when processed by a processor (5).
